(19) United States
(12) Patent Application Publication
(10) Pub. No.: US 2008/0178296 A1
(43) Pub. Date: Jul. 24, 2008

(54) Method and Device For Protecting the Contents of an Information Carrier

(75) Inventor: Johannes Hendrikus Maria Lemmers, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/909,473

(22) PCT Filed: Mar. 15, 2006
(86) PCT No.: PCT/IB06/50803

§ 371 Date: Sep. 24, 2007

(30) Foreign Application Priority Data
Mar. 29, 2005 (EP) 05102452.9

(51) Int. Cl. G06F 21/00

(52) U.S. Cl. 726/27

(57) ABSTRACT

A machine-readable information carrier (2) contains content (video, audio, photographs, software, data; 20A; 20B) with restricted access, wherein at least one portion (23) of the content is a restricted portion. The information carrier (2) further contains data (21) associated with the said content, the data (21) representing a machine-executable access application which contains machine-executable instructions for a reader device (3, 3A) for controlling the reader device's access to the content of said carrier. The access application (21) is designed, when the reader device attempts an access to the restricted portion (23) of the content, to check authorization of the reader device, and to deny access to information in the said restricted portion (23) of the content if it finds that the reader device is unauthorized or to allow access to information in the said restricted portion (23) of the content if it finds that the reader device is authorized.

### FIELD OF THE INVENTION

The present invention relates in general to a method for restricting access to computer-readable information contained in an information carrier, especially information stored on an optical disc. Further, the present invention relates to an information carrier with restricting access.

### BACKGROUND OF THE INVENTION

In the following, the phrase “information carrier” will be used as a general phrase indicating an entity which is capable of carrying information and be accessed by a reading device. In a specific case, the information carrier will be an optical disc, and the reading device will be an optical disc drive; the invention will hereinafter be explained in further detail for this case. It is noted, however, that the use of the invention is not restricted to optical discs. For instance, the information carrier may also involve a network, such as the Internet, comprising a memory with information, and the reading device may involve a personal computer linked to this network, either by a wired link or a wireless link.

As is known to persons skilled in the art, an optical storage disc comprises at least one track, either in the form of a continuous spiral or in the form of multiple concentric circles, of storage space where information may be stored in the form of a data pattern. Optical discs may be of the read-only type, where information is recorded during manufacturing, in which case a user can only read the information. The optical storage disc may also be a writable type, in which case a user can also store information. For reading information from the disc, an optical disc drive comprises, on the one hand, rotating means for receiving and rotating an optical disc, and on the other hand optical scanning means for generating an optical beam, typically a laser beam, and for scanning the storage track with said laser beam. Since the technology of optical discs in general, the way in which information can be stored on an optical disc, and the way in which information can be read from an optical disc, is commonly known, it is not necessary here to describe this technology in more detail.

The information on the disc may be of different types, resulting, if properly processed by a proper reading device, for instance in video or audio or photographs. The information on the disc may also contain executable instructions of a computer program (software). The information on the disc may also contain a database, for instance a list of bank numbers or the like. In the following, the word “content” will be used to relate to all possible types of information.

In principle, the content of an information carrier is accessible to each and every reader, as long as the reader is of a type corresponding to the type of information carrier. However, it may be that it is undesirable for a certain part of the content to be freely accessible. For instance, it may be that (part of) the content is secret. Or, it may be that (part of) the content has commercial value. By way of illustrative example, a film (movie) is mentioned. A commercial company may earn money by selling discs with one or more films stored thereon. Usually, if such disc has been sold, its contents can be viewed freely, as many times as the owner wishes. The disc may be given (or sold) to family and friends, who may also watch the film. The company receives its revenue only once: the selling price of the disc. Since this revenue is independent of the number of times that the film is watched, while the company wishes to take into account that the film is watched many times by other people, the selling price of the disc is relatively high, which makes it interesting to try to make illegal copies. In one aspect of the present invention it would be advantageous if the selling price was relatively low, whereas a small fee would be paid each time the film was played.

Thus, there is a general desire to restrict access to the content of a medium, where the access would only be allowed if the requesting user has fulfilled a predetermined condition; this condition may be the making of a certain payment, but the condition may also be the entering of a key word or the like.

In a typical prior art approach, information is shielded by coding schemes. The information is stored in a coded or encrypted manner, and can only be “used” by a user who has a key for decoding. The coded content is freely accessible to a reader, but without a key for decoding the reader has no access to the actual information.

A disadvantage of this prior art approach is that the reading apparatus must continuously perform the decoding operation on the information read from the disc, which requires high-quality processing speed and therefore a relatively expensive processor. A further disadvantage of this prior art approach is that, while avoiding unauthorized access to shielded information, it does not avoid multiple access by an authorized user. A further disadvantage of this prior art approach is that the rules implementing the decoding algorithm are fixed in the reading apparatus. A further disadvantage of this prior art approach is that, once an encryption key becomes public, all contents encrypted with this key become publicly available.

It is an objective of the present invention to overcome or at least reduce all or at least some of the above problems.

### SUMMARY OF THE INVENTION

According to an important aspect of the present invention, an information carrying medium carries at least one application. It is noted that the BD-J standard (or BD-J specification), which is still under development, allows Java applications to be stored on disc, but the invention is not restricted to Java applications: the principles of the present invention can be practiced irrespective of the language of the applications.

A reader which is designed to support the application in accordance with the present invention, will recognize the presence of the application, will read the application and store it in its memory. The application may be self-starting, but it may also be that the application only starts running after receiving a user-command.

Once running, the application will control the access to the information on the medium. Thus, the application, acting as a guard dog as it were, may give access to certain information if it finds that a predetermined condition has been fulfilled, such as for instance a certain fee has been paid. In a reader which does not support the application to take control, or in a case where the user does not start the application, or in a case where the user does not fulfil the predetermined condition, the user will find that some part or all information on the disc is not available to him.

Thus, it is possible that each film has its own guard dog application, and that different films have different guard dog applications. In fact, each film distributor may develop its own applications for guarding the contents of its own discs.

### BRIEF DESCRIPTION OF THE DRAWINGS

These and other aspects, features and advantages of the present invention will be further explained by the following description of a preferred embodiment with reference to the drawings, in which the same reference numerals indicate the same or similar parts, and in which:

FIG. 1A is a block diagram schematically illustrating a reproduction system;

FIG. 1B is a block diagram schematically illustrating another type of reproduction system;

FIG. 2 is a diagram schematically illustrating the storage of movies on a disc;

FIG. 3 is a block diagram schematically illustrating an aspect of the operation of a disc drive in accordance with the present invention;

FIG. 4A schematically illustrates that a movie comprises a succession of clips;

FIG. 4B schematically illustrates that clips may be stored in a non-sequential order;

FIG. 4C schematically illustrates a playlist;

FIGS. 5A-5C illustrate manipulation of the playlist.

### DETAILED DESCRIPTION OF THE INVENTION

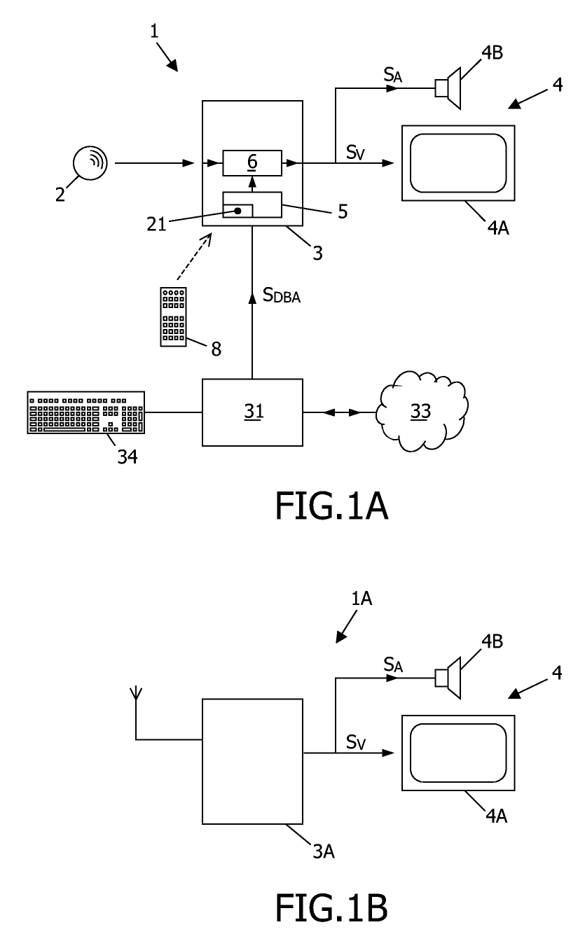

FIG. 1A schematically shows a reproduction system 1, for reproducing video stored on a storage medium or information carrier 2. In the following explanation it will be assumed that the information carrier is an optical disc, but the present invention can also be practiced with different types of information carrier. Since optical discs are known per se, it is not necessary here to explain in great detail how information can be stored on and read from an optical disc.

In a particular example, the optical disc may be a BluRay Disc, especially a disc according to the BD-J format/standard.

In an illustrative example, the disc contains a film (movie). The disc may also contain a documentary. Whatever the nature of the contents of the disc, it typically involves a combination of images (video) and sound (audio).

The reproduction system 1 comprises a reader 3, in this example an optical disc drive, for reading information from the disc 2 and for generating a video output signal SV for an image display device 4A, for instance a monitor or a television screen or the like, of a display apparatus 4. The drive 3 will also generate an audio output signal SA for one or more loudspeakers 4B of the display device 4.

FIG. 1B illustrates an alternative reproduction system 1, where the disc drive 3 is replaced by a receiver 3A, suitable for receiving a transmission signal carrying the data representing a film. The transmission signal may be a signal travelling through air, picked up by an antenna, as illustrated, but the transmission signal may also travel by cable or another type of conductor. In such embodiment, the data as received will be stored in a memory associated with the receiver 3A, and the actual playback will be effected from such memory, which may be considered an analogon of the disc 2. In the following, however, the explanation will refer to FIG. 1A.

The disc drive 3 comprises a data processing device 6, typically implemented, at least partially, in software. This data processing device 6 receives and processes the incoming data read from disc to generate the display signal SA, SV.

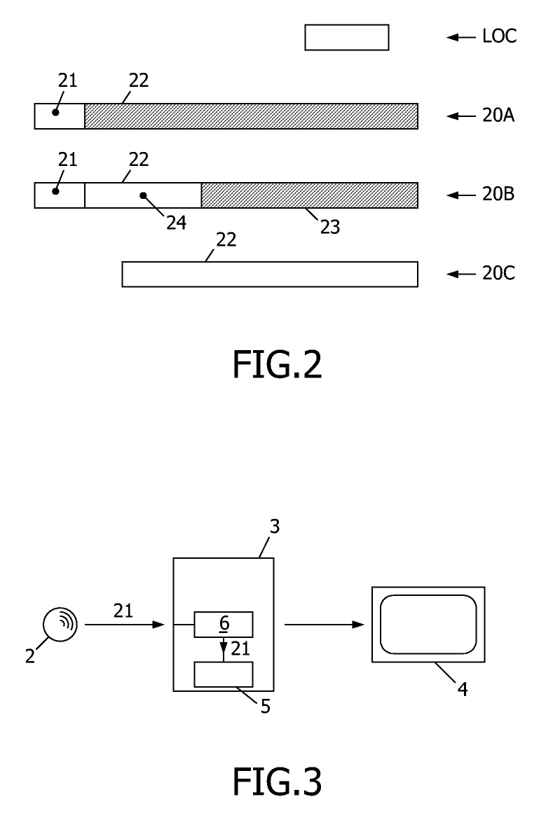

In FIG. 2, a film 20 is shown as a horizontal ribbon, representing the collection of images (and sound) to be displayed on the display device 4. It is noted that techniques for coding video and storing such video on the disc, and techniques for reconstructing a video display signal on the basis of data read from the disc, are techniques known per se, so it is not necessary here to explain these techniques in further detail.

The disc 2 may contain more than one film 20. FIG. 2 illustrates three different films 20, distinguished from each other by the addition of characters A, B, C. The disc 2 may further contain a list of contents LOC, also indicated in FIG. 2. When a user inserts the disc 2 into the disc drive 3, the disc drive 3 will first read the list of contents LOC and display its information on the image display device 4A, allowing the user to choose which film, also indicated as title, he wishes to see. The user can input his choice using a remote control 8 or other suitable type of input device. For instance, if the reproduction system 1 is implemented as a PC or laptop, the user can input his choice using the keyboard (not shown) of such PC or laptop. Then, the disc drive 3 starts reading the selected film 20.

According to an important feature of the present invention, the disc 2 contains at least one film with restricted access. The fact that a film is not freely accessible is indicated in FIG. 2 by a hatched area 23. The restriction of the access may involve the entire film, indicated for film 20A, but the restriction of the access may also involve a part of the film only, indicated for film 20B, where the non-hatched area 24 indicates a part of the film that is freely accessible. The disc may also contain one or more films which are entirely freely accessible, indicated for film 20C.

According to an important feature of the present invention, a film 20A, 20B with restricted access, as stored on disc, comprises data 22 representing the actual pictures and audio, plus data 21 representing application software. Typically, each film will have its own application software, but it is also possible for the disc 2 to contain only one application common to all films 20. It is noted that the BD-J standard, which is still under development, allows Java applications to be stored on disc, but the invention is not restricted to Java applications: the principles of the present invention can be practiced irrespective of the language of the applications. With the application software 21 running, it becomes an integral part of the data processing device 6 of the disc drive 3. In the case of the BD-J example, it is noted that any disc drive which is BD-J compliant will run the application 21 as part of its data processing device 6. A disc drive which is not BD-J compliant will generate its display signal S on the basis of the data 22 in the usual way, without benefiting from the advantages offered by the application software 21 of the present invention.

It is noted that a film which is freely accessible does not need to have an associated application, as illustrated for movie 20C. On the other hand, it is also possible that an unrestricted movie 20C also has an application associated therewith.

The disc drive 3 is designed to determine whether or not the selected film 20 has application software 21 associated therewith. It is noted that, as films, whether restricted (20A, 20B) or unrestricted (20C), always have application software associated therewith, the disc drive 3 does not need to investigate whether the selected film 20 has application software 21 associated therewith.

In case a film (20C) selected by the user does not have application software associated therewith, the disc drive may read and play the film as usual. In the following it will be assumed that the user has selected a film with restricted access.

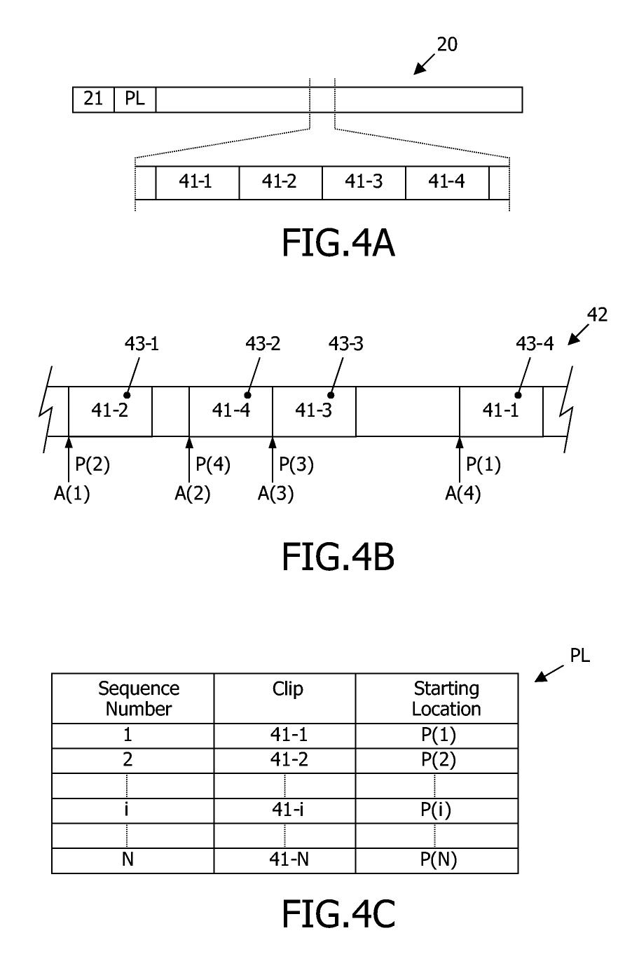

Thus, in response to receiving the user selection, the disc drive 3 is designed to first read the application software 21 associated with the selected film 20, and store it in its memory 5, as illustrated in FIG. 3. Further, the disc drive 3 is designed to execute the application software 21 as soon as it has been received completely; then, the application software 21 is functionally in control of the processing device 6, as illustrated in FIG. 1. One might also say that the application software 21 has become part of the processing device 6. In any case, the further functioning of the disc drive is determined by the application software.

The application software 21 determines the access to the associated film; therefore, in the following, the application software 21 will be indicated as “access application”. It is an important feature of the present invention that the access application is associated with the film on disc. This allows a disc manufacturer, or a movie editor, to freely determine how access to the film is defined and protected. It is not necessary to incorporate such access application into the standard software resident in the disc drive, nor are manufacturers or editors confined by “old” access application definitions. After having designed a “new” access application associated with a certain film, such film can be played even with existing players without the need for modifying those players, simply because the “new” access application will automatically be provided in association with the film, and an existing player will automatically read and hence “obey” the “new” access application.

In a possible embodiment, the film 20B contains a free film portion 24 and a restricted film portion 23. For instance, the free film portion 24 may involve a commercial showing what the actual film (i.e. restricted film portion 23) is about, so as to stimulate the user's interest. As another example, the free film portion 24 may involve a first part of the actual film, while the remainder part of the film is restricted.

With the access application 21 running, the disc drive 3 receives the data relating to the free film portion 24 of movie 20B, which is processed by processing device 6 to generate an output signal SV, SA for the display apparatus 4, allowing the user to watch this film portion 24. Then, when the disc drive 3 reaches the end of the free film portion 24, reading and display of the film will be stopped, and a message will be displayed on the screen 4A, inviting the user to perform a payment transaction in order to be able to watch the remainder of the movie.

It is noted that, in case the entire movie 20A has restricted access, this invitation will be displayed immediately after receiving the user's choice, without first displaying a free movie portion.

It is further noted that, instead of performing a payment transaction, the user may be invited to perform some other kind of action, as predefined in the access software for meeting a condition defined in the access software. The nature of this action is not critical for implementing the present invention; by way of example, it is even possible that the user has to enter a certain code. Such action will hereinafter in general be referred to as de-blocking action.

The access application 21 is designed to check whether the de-blocking action has been performed correctly. For instance, the disc drive 3 may be associated with a payment device 31, for instance a card reader for reading a credit card or chip card or the like, capable of communicating a remote payment instruction through a network 33 such as for instance the Internet or a telephone network. It is also possible that the payment device 31 involves a PC for logging in on a website of a disc distributor, receiving a de-blocking code from this site if the user had previously arranged payment, for instance by wiring transfer. In any case, a signal S_{DBA} issued by the payment device 31, indicating that the user has correctly performed the de-blocking action, is received by the access application 21. If the access application 21 finds that the de-blocking action has been performed correctly, the disc drive 3 will continue reading the restricted film portion 23 of the film 20B and displaying this film portion on the display apparatus 4.

An important advantage of the present invention is that it allows a distributor to design the access application so as to ensure that a payment is made each time a user wishes to watch the restricted film portion 23. If the user wishes to watch the film more than once, the distributor receives payment more than once. This advantage is also achieved if the user makes a copy of the disc: the copy will have the same contents as the original, including the access application, and display of the copy is only possible after making a payment.

On the other hand, it may happen that a user who is watching the restricted film portion 23 after having made a payment wishes to interrupt the display, take out the disc from the disc drive, and resume display at a later time. It would be preferred that the user need not pay again. Therefore, in a preferred embodiment, the access application is designed, in response to receiving a stop and eject command from the user, to store in the memory 5 interruption information relating to the identity of the disc, the film currently being watched, the current location within the film, and the status “unblocked”, i.e. indication that the user has paid for watching this film but has only watched up to a certain location. The access application is further designed, when a user enters a disc and selects a certain film, to consult this memory 5 for such interruption information and, if it finds interruption information relating to the film selected by the user, to display a message indicating that the user has ended a previous session without watching the film up to the end, and inviting the user to indicate that he wishes to continue watching the movie from the location where he left it. Then, in response to receiving a corresponding user command, the access application may start playing the movie from this location, or preferably starting some time before this location to allow the user to “recognize”, without asking for a further payment, i.e. without checking the de-blocking action.

In one possible embodiment, film data themselves are stored in a normal way, accessible to the disc drive, while the access application is designed to simply deny access to the restricted film portion 23 until it finds that the de-blocking action has been performed correctly. The denial may just involve playout (including fast forward and fast reverse), but the denial may also involve selection of and jumps to hidden contents. This simple approach functions properly as long as a properly designed disc drive is used, i.e. a disc drive complying with the requirement that disc access always be controlled by an access application read from a disc. It would, however, be possible to build a non-compliant disc drive which ignores any access application; such non-compliant disc drive would be able to access the disc contents, restricted or not, irrespective of any payment made by the user.

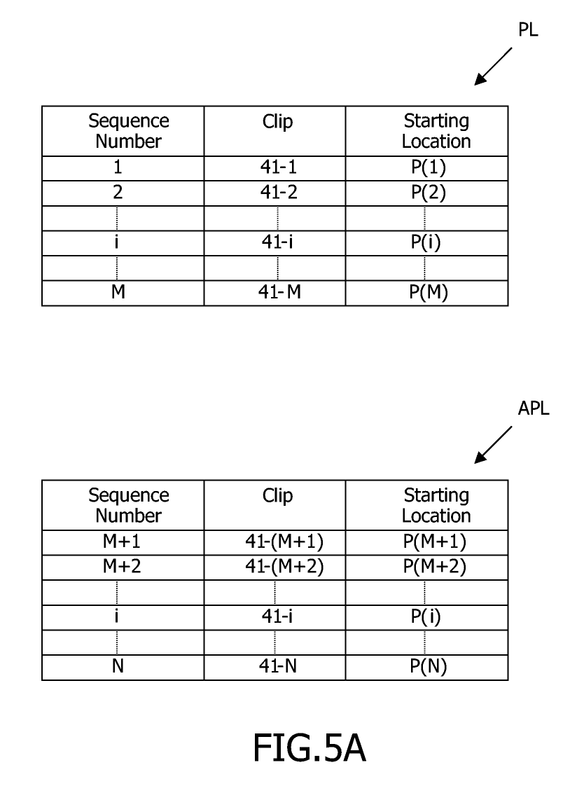

In a preferred embodiment, it is ensured that the disc drive is obliged to run the access application, or else the film cannot be watched. In such implementation, a restricted film portion would be protected against access by a non-compliant disc drive. An example of such preferred embodiment will be discussed with reference to FIGS. 4A-4C.

FIG. 4A illustrates that a film 20 comprises a succession of film portions 41-1, 41-2, 41-3, 41-4, etc. Each film portion may involve one single frame only, but each film portion may also comprise a plurality of frames involving a certain play time larger than one frame. In the following, such film portion 41-i will be indicated as “clip”. De clips 41-i, which do not need to have the same length, are considered to contain audio as well as video.

It is possible that all clips are stored on the disc 2 in the order in which they are played. Then, in the storage space, the first frame of a clip follows immediately behind the last frame of the previous clip, and the film can simply be read from the disc in a sequential order.

However, in general the clips are not necessarily stored in a sequential order. In FIG. 4B, a track 42 of the disc 2 is depicted as a ribbon. As is known, storage locations in the track 42 have a certain address. In general, the clips 41 have a duration longer than one storage location, so that a storage portion 43 for storing a clip 41 comprises multiple storage locations. In FIG. 4B, four storage portions 43-1, 43-2, 43-3, 43-4 are shown, in that order, having starting addresses A(1), A(2), A(3), A(4), respectively, so that A(1)<A(2)<A(3)<A(4).

Each storage portion 43-1, 43-2, 43-3, 43-4 contains one corresponding clip 41. Clips may be written in adjacent storage portions (see portions 43-2 and 43-3), but it is also possible for the storage space between adjacent clips to be empty (see between portions 43-3 and 43-4) or contains information relating to a different film. In any case, the track order of the storage portions 43-1, 43-2, 43-3, 43-4 does not necessarily correspond to the playing order of the clips 41-i.

In FIG. 4B, a first clip 41-1 is stored in storage portion 43-4. The starting location of this storage portion 43-4 is indicated as P(1); in this example, P(1)=A(4). The next clip 41-2 is stored in storage portion 43-2; the starting location of this storage portion 43-2 is indicated as P(2); in this example, P(2)=A(1). When a disc drive reaches the end of the first clip 41-1, it must jump to the starting location P(2) of the second clip 41-2, i.e. to address A(1). If the disc drive does not have this information, it cannot play the second clip, hence it cannot play the film 20.

Thus, in general, a film 20 comprising N clips 41-1 to 41-N is associated with a play list PL, also stored on the disc as illustrated in FIG. 4A. Such play list contains at least one table relating to a clip sequence number i with a starting location P(i), for i in the range from 1 to N, as illustrated in FIG. 4C. It is noted that the end of a clip may be indicated in each clip itself, or the play list may also indicate the length of each clip.

When a disc drive starts reading a film, it first reads the play list PL and stores this list in its memory 5. Then, the disc drive starts reading the first clip 41-1 of the movie at first starting address A(1). Undisturbed playback is only possible if the playlist PL is correct. According to a possible implementation of the present invention, the playlist is manipulated in order to prevent a non-compliant disc drive from reading the film.

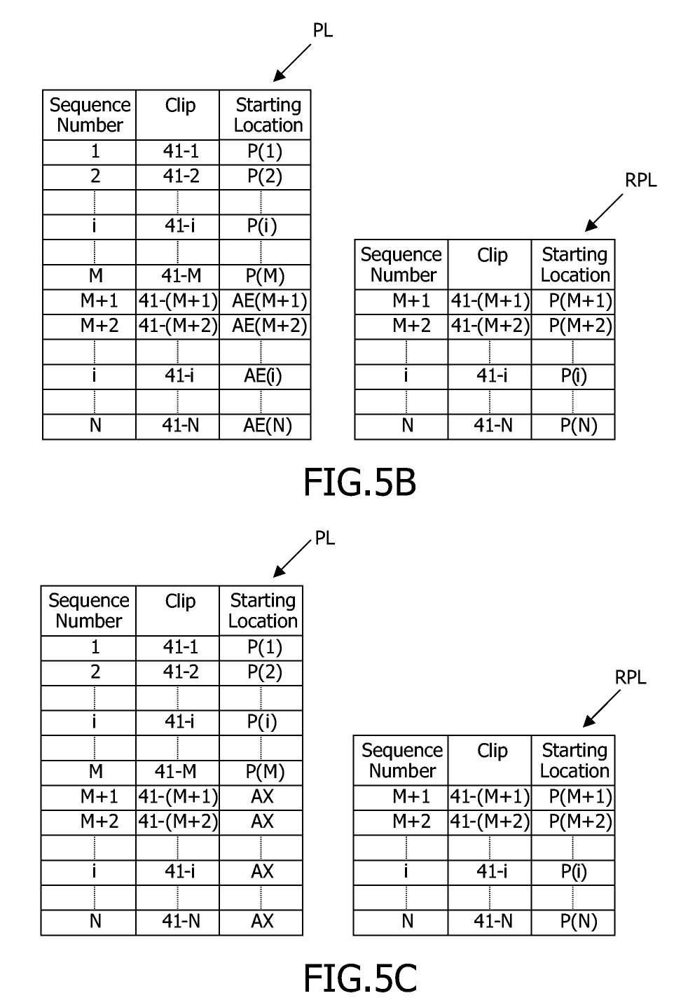

In a possible embodiment, illustrated in FIG. 5A, the playlist PL as stored on the disc only relates to the non-restricted film portion 24. Thus, when the non-restricted film portion 24 concerns the clips 41-i for i=1 to M, while the restricted film portion 23 concerns the clips 41-i for i=M+1 to N, M and N being integers with N>M, the playlist PL as stored on the disc only contains clip starting locations P(i) for i=1 to M. The playlist does not contain any addresses of the locations where clips of the restricted film portion 23 are stored, so the disc drive cannot read such clips. In fact, as far as the disc drive is concerned, it has completely played the film when it has finished playing the last clip 41-M indicated in the playlist. In this embodiment, the access application 21 may contain an additional playlist APL relating to the clip starting locations P(i) for i=M+1 to N of the locations where clips of the restricted film portion 23 are stored; after having found that the user has performed the de-blocking act, the access application 21 uses this additional playlist for continuing playback.

In another possible embodiment, the playlist PL as stored on the disc, as far as the locations are concerned where clips 41-i for i=M+1 to N of the restricted film portion 23 are stored, contains erroneous addresses AE(i), causing further playback on the basis of this list to result in garbage. In this embodiment, the access application 21 may contain a replacement playlist RPL relating to the correct starting locations P(i) of the locations where clips of the restricted film portion 23 are stored; after having found that the user has performed the de-blocking act, the access application 21 uses this replacement playlist RPL for continuing playback. It is also possible that the access application contains a formula for calculating correct addresses on the basis of the addresses contained in the playlist PL as stored on the disc. In a simple embodiment, an erroneous address AE(i) may be calculated on the basis of a correct address AC(i) using a formula AE(i)=2·AC(i). Then, during playback under the control of the access application, clip 41-i is found by the access application at address AL(i)/2, wherein AL(i) indicates the address as mentioned for the i-th clip in the list PL as stored on disc.

In yet another possible embodiment, the playlist PL as stored on the disc, as far as the locations are concerned where clips 41-i for i=M+1 to N of the restricted movie portion 23 are stored, contains only one address AX, resulting in repeated playback of only one clip. In this embodiment, the access application 21 may contain a replacement playlist RPL relating to the correct addresses P(i) of the locations where clips of the restricted film portion 23 are stored; after having found that the user has performed the de-blocking act, the access application 21 uses this replacement playlist RPL for continuing playback.

Thus, in the above examples, the playlist PL of a film 20, as stored on disc 2, deviates from the correct playlist, and only the access application 21 has information capable of constructing a correct list. A non-compliant disc drive may be capable of playing on the basis on the playlist PL, but this does not result in playing the desired film since the playlist contains incorrect information.

The access application may be designed to operate on the basis of different operational principles. For example, the access application may be designed to allow playback of the first 5 minutes of a film, i.e. on the basis of a time code.

Further, the access application may be designed to monitor the portion of the film that is being played. If it finds that a restricted portion is being played, the access application may stop the playback. Such solution is useful if it is possible for a user to jump towards a restricted area. On the other hand, it is also possible for the access application to be designed to monitor navigation information, specifically user commands and, if it finds that the user issues an illegal command (for instance a fast forward or feed command, if such would result in entering a restricted portion of the film), to suppress this command.

It should be clear to a person skilled in the art that the present invention is not limited to the exemplary embodiments discussed above, but that several variations and modifications are possible within the protective scope of the invention as defined in the appending claims. For instance, the film data may also be encrypted, with only the access application having the corresponding key for decryption.

Further, the playlist may be subdivided into play items.

In the above, the present invention has been explained with reference to block diagrams, which illustrate functional blocks of the device according to the present invention. It is to be understood that one or more of these functional blocks may be implemented in hardware, where the function of such functional block is performed by individual hardware components, but it is also possible that one or more of these functional blocks are implemented in software, so that the function of such functional block is performed by one or more program lines of a computer program or a programmable device such as a microprocessor, microcontroller, digital signal processor, etc.

1. Machine-readable information carrier (2) containing content (video, audio, photographs, software, data; 20A; 20B) with restricted access, wherein at least one portion (23) of the content is a restricted portion;
wherein the information carrier (2) further contains data (21) associated with the said content, the data (21) representing a machine-executable access application;
wherein the access application (21) contains machine-executable instructions for a reader device (3, 3A) for controlling the reader device's access to the content of said carrier;
wherein the access application (21) is designed to check an authorization of the reader device, and to deny access to information in the said restricted portion (23) of the content if it finds that the reader device is unauthorized, or to allow access to information in the said restricted portion (23) of the content if it finds that the reader device is authorized.

2. Information carrier according to claim 1, wherein the said information carrier (2) is an optical disc, preferably according to the BD-J format, and wherein the said reader device (3) comprises a disc drive.

3. Information carrier according to claim 1, wherein the said information carrier (2) is a data carrying signal, and wherein the said reader device (3A) comprises a data carrying signal receiver.

4. Information carrier according to claim 3, wherein the data carrying signal is transferred via a network such as for example the Internet.

5. Information carrier according to claim 1, wherein the access application (21) is self-starting.

6. Information carrier according to claim 1, wherein the access application (21) is designed to check whether a pre-defined de-blocking action has been performed.

7. Information carrier according to claim 6, wherein the de-blocking action involves a payment action.

8. Information carrier according to claim 1, wherein the access application (21) is designed, in response to receiving a stop command effectively interrupting authorized access to the restricted portion (23) of the content, to store status information in a memory (5) of the reader device (3);
and wherein the access application (21) is designed to check authorization of the reader device by consulting the status information in said memory (5).

9. Information carrier according to claim 1, wherein the carrier contains a playlist (PL) associated with the said content, the playlist (PL) containing information on starting locations (P(i)) of clips (41-i) of the said content;
wherein the playlist (PL) associated with a restricted portion (23) of the content is a manipulated playlist deviating from the correct playlist;
and wherein the access application (21) contains information for providing the correct playlist.

10. Information carrier according to claim 9, wherein the access application (21), if it finds that the reader device is authorized, is designed to provide the correct playlist, or else, if it finds that the reader device is authorized, to allow playback on the basis of the original playlist (PL) as contained in the carrier.

11. Information carrier according to claim 9, wherein the playlist (PL) only relates to starting locations (P(i)) of clips (41-i, for i=1 to M) of non-restricted portions (24) of the said content;
wherein the access application (21) contains an additional playlist (APL) relating to starting locations (P(i)) of clips (41-i, for i=M+1 to N) of restricted portions (23) of the said content;
and wherein the access application (21), if it finds that the reader device is authorized, is designed to add the additional playlist (APL) to the original playlist (PL) as contained in the carrier.

12. Information carrier according to claim 9, wherein the playlist (PL), in respect of clips (41-i, for i=M+1 to N) of restricted portions (23) of the said content, contains erroneous addresses (AE(i); AX);
wherein the access application (21) contains a replacement playlist (RPL) relating to starting locations (P(i)) of said clips (41-i, for i=M+1 to N) of restricted portions (23) of the said content;
and wherein the access application (21), if it finds that the reader device is authorized, is designed to replace the original playlist (PL) by the replacement playlist (RPL) in respect of said clips (41-i, for i=M+1 to N) of restricted portions (23) of the said content.

13. Information carrier according to claim 9, wherein the playlist (PL), in respect of clips (41-i, for i=M+1 to N) of restricted portions (23) of the said content, contains erroneous addresses (AE(i));
and wherein the access application (21), if it finds that the reader device is authorized, is designed to calculate correct addresses (AC(i)) on the basis of said erroneous addresses (AE(i)).

14. Access application (21), stored on an information carrier (2) in association with a certain content (20) of the carrier, wherein at least one portion (23) of the content is a restricted portion;
the access application (21) comprising machine-executable instructions for a reader device (3) for controlling the reader device's access to the said content of an information carrier (2);
wherein the access application (21) is designed to check authorization of the reader device, and to deny access to information in the said restricted portion (23) of the content if it finds that the reader device is unauthorized or to allow access to information in the said restricted portion (23) of the content if it finds that the reader device is authorized.

15. Access application according to claim 14, wherein the access application (21) is designed to check whether a pre-defined de-blocking action has been performed.

16. Access application according to claim 14, wherein the access application (21) is designed, in response to receiving a stop command effectively interrupting authorized access to the restricted portion (23) of the content, to store status information in a memory (5) of the reader device (3);
and wherein the access application (21) is designed to check authorization of the reader device by consulting the status information in said memory (5).

17. Access application according to claim 14, wherein the access application (21) contains playlist information (APL; RPL; AC(i)) for changing a playlist (PL).

18. Disc drive (3) having an operational memory for storing software therein, the operational memory containing an access application (21) according to claim 14.

19. Disc drive according to claim 18, provided with a payment device (31) for effecting a remote payment.

20. Method for protecting at least a restricted portion (23) of the contents of an information carrier, the method comprising the steps of:
providing a playlist (PL) with erroneous address information;
providing information for correcting the playlist (PL) with erroneous address information;
detecting a request for access to the restricted portion (23) of the contents;
checking the authorization for the access;
correcting the playlist if authorization is established.
